(19) United States
(12) Patent Application Publication
(10) Pub. No.: US 2019/0362603 A1
(43) Pub. Date: Nov. 28, 2019

(54) Hot Links 29

(71) Applicant: Eric Johnson, Midlothian, VA (US)

(72) Inventor: Eric Johnson, Midlothian, VA (US)

(73) Assignee: Eric Johnson, Midlothian, VA (US)

(21) Appl. No.: 16/153,720

(22) Filed: Oct. 6, 2018

Related U.S. Application Data
(60) Provisional application No. 62/676,189, filed on May 24, 2018.

(51) Int. Cl. G07F 17/32; A63F 1/00; G06Q 50/34

(52) U.S. Cl. CPC G07F 17/3293; G07F 17/3267; A63F 2001/005; A63F 1/00; G06Q 50/34; G07F 17/3244

(57) ABSTRACT

The invention relates to a casino game for live play and play through an electronic device and including methods for playing the casino game. The casino game includes a deck of cards having at least two series of cards having values 1-n wherein n is any whole number; and at least two colors, wherein each series of the at least two series of cards consists of cards having the same color. The game also includes Ante wagers and Bonus wagers each having separate win conditions and payout odds where the Ante wagers win conditions require obtaining a total card value between a predetermined numerical range.

This application claims the benefit of the filing date of U.S. Provisional Application Ser. No. 62/676,189 filed May 24, 2018, which is incorporated by reference herein.

### BACKGROUND OF THE INVENTION

Gamblers enjoy side betting in games to double the opportunity of winning as well as to have another opportunity to gamble. But there is also a need to preserve the integrity of the game being played to maintain the original unadulterated use of cards and play so that the original card game is not altered by the optional side betting activity; and that players can play the original casino card game without the optional side betting if they choose. Prior art casino card games provide a number of community cards dealt face down on a playing table to be combined with cards dealt to each player and often are directed to traditional poker hand quality determinations. For example, three card poker offers altered poker hand quality determinations based whether the community cards are being considered or not.

Some casino games also offer side bets which allow for increased payouts if certain low probability card combinations are obtained by the player or in some instances dealt to the player, for example, a full house or royal flush.

Poker games played against other players and/or against a dealer add a level of difficulty and human judgment which complicates winning rather than just winning on the value of the cards themselves against a payout table. The payout table game provides a faster game and more certainty on the part of the player that a hand will pay off, even if the player lacks competitive play skill, and also does not depend upon how good or how bad the hands of the other players or the dealer may be.

U.S. Pat. No. 9,564,016 is directed to a game called criss cross poker which includes both vertical and horizontal axis community cards which share a common center. Players can wager on both the vertical axis community cards and the horizontal axis community cards. The patent also includes the following prior art citations:

U.S. patent application Ser. No. 13/371,903, published Jun. 14, 2012 by Nicely et al, discloses a gaming device that provides a single player poker game including one or more opportunities for forming player hands. In one embodiment, for a play of the poker game, a player places a wager on each of a plurality of player hands. The gaming device provides the player with one or more opportunities to fold one or more of the player hands and withdraw the wager associated with the folded hand. A number of community cards are dealt. The gaming device determines and provides any awards associated with a ranking of each of the remaining player hands according to a payout table.

However, there is no prior art games which provides the same structure, gameplay, or payouts as the Hot Links 29 game.

### SUMMARY OF THE INVENTION

The current invention is directed to a casino style game and method of playing thereof including a specific game structure, betting format, and payout structure. Hot Links 29 is a house banked card game played with a unique deck of 65 cards. In the preferred embodiments the unique deck of 65 cards is the deck of cards described in U.S. 62/676,189. The disclosure of U.S. 62/676,189 is hereby incorporated by reference. The 65-card deck consists of 5 series of 13 different cards which comprise a card which represent either a 1 or a 14 (1/14 card), and 12 cards representing values of 2 through 13. The cards are of five different colors where each 1-14 series of cards is a particular and distinct color. For example, in the preferred embodiments the cards are green, blue, purple, orange, and red. The 11, 12, 13, and 1/14 cards can optionally be substituted for the Jack, Queen, King and Ace cards. Typically the Ace card is the 1/14 card.

In some embodiments, of the invention the game is played in the following manner: Play begins by each player placing an Ante wager. Optionally, they may also place a Bonus wager. In the preferred embodiment a player may not place a Bonus wager without also placing an Ante wager. In an alternative embodiment, a player may place a Bonus wager without placing an Ante wager. In some embodiments, a player may place a Bonus wager on a separate/different player's hand who has placed an Ante wager but not a Bonus wager.

The dealer deals each player who has made a qualifying wager two cards optionally face up, face down, or either. A qualifying wager being an Ante wager and/or Bonus wager meeting the requirements of the particular game e.g., satisfying a minimum bet requirement. The dealer also deals five community cards face down.

Community cards are revealed one at a time, and added to the value of the player's cards until the player's cards reach a minimum value of twenty-five.

In the preferred embodiment, in order to win the Ante wager, the total value of the player's cards and revealed community cards must have a minimum value of twenty five and a maximum value of twenty-nine. If the total value of the player's cards and revealed community cards exceeds twenty-nine at any point or if the total value of the player's cards and revealed community cards does not reach 25 when all community cards have been revealed, the dealer continues dealing and revealing more community cards until the total value of the player's cards and revealed community cards reaches at least 25. In an alternative embodiment, if the total value of the player's cards and revealed community cards does not reach 25 when all community cards have been revealed, Ante wager is lost.

In some embodiments, there is a maximum of 6 players. In some embodiments, when a player wins the Ante wager, the player is paid according to the win conditions and if they have an additional Bonus wager, their cards are turned face down to represent their Ante wager has been resolved. If the player loses the Ante wager their chips for the Ante wager are removed from the table and if they have an additional Bonus wager their cards are turned faced down to represent their Ante wager has been resolved. If the player does not have a Bonus wager the player's cards will be removed from the table after the Ante wager is resolved.

In some embodiments, the community cards are revealed one at a time until all players have either won or lost the Ante wager. When a community card is revealed and all the players have either won or lost the Ante wager using that community card, the remaining community cards can be revealed all at once. In some embodiments, once the player uses a community card to achieve a winning value, the Ante wager is over.

The Ante wager is won when the total value of a player's hand is twenty-five thru twenty-nine. In the preferred embodiment, the Ante wager is paid at 3 to 2 odds for hand values of twenty-five thru twenty-eight and the Ante wager is paid at 2 to 1 odds for a value of twenty-nine.

To win the Bonus wager each player who has placed a Bonus wager combines their cards with the community cards as they are revealed and compares their combination of cards to the Bonus wager payout table which lists all win conditions and payouts. When the combination of the eligible player's cards and community cards satisfy a win condition of the Bonus wager payout table, the eligible player is paid in accordance to the Bonus wager payout table.

In the preferred embodiment, the game concludes once all community cards have been revealed and/or once all Ante wagers and Bonus wagers have been decided, and all Ante wagers and Bonus wagers have been resolved, i.e. winning wagers payed and losing wagers lost/collected.

The Ante wager must be placed before the player receives their initial two cards. The Ante wager is resolved based on the total value of the player's cards plus revealed community cards reaching a minimum value of twenty-five up to a maximum value of twenty-nine. If the value of the player's cards plus revealed community cards are greater than twenty-nine the player loses the Ante wager.

In some embodiments, the players may optionally, only once, split cards that are pairs. The dealer will deal an additional card to each of the player's hands caused by the split before revealing a community card. If the total value of a player's cards is less than twenty-five, the dealer will reveal community cards until the total value of each of the player's cards reaches a minimum value of twenty-five or a maximum value of twenty-nine. In the preferred embodiment the game ends when all players have card values greater than twenty-five where winning players have card values of twenty-five to twenty-nine and losing players have card values of greater than 29. In the preferred embodiment, there is no maximum number of community cards which can be revealed. In the preferred embodiment, if more than five community cards are dealt, only the first five community cards are used to determine the bonus wager outcomes.

In some embodiments, a maximum of five community cards may be revealed and players with a total card value of less than 25 after all community cards are revealed lose the game.

In the preferred embodiment, the players whom initial two cards are less than twenty-five may place an additional Ante wager before each community card is revealed. In the preferred embodiment, the additional Ante wager must be an amount equal to the amount of the initial Ante wager. In alternative embodiments, the player may wager different amounts than the original wager. In the preferred embodiment, the Ante wager is paid at 3 to 2 odds to the players that reach a value of twenty-five thru twenty-eight. The Ante wager is paid at 2 to 1 odds to the players that reach a value of twenty-nine. The community cards revealed are only the amount needed to resolve the player's Ante wager. Additional community cards may be revealed/dealt one at a time if needed to resolve the Ante wager.

The payouts for various win conditions can be varied. Examples of some preferred payout options are shown in Table 1 below.

TABLE 1
Ante-Payout Table

| | Version2 | Version3 | Version4 | Version5 | Version6 |
|---|---|---|---|---|---|
| Scenario | Payout | Payout | Payout | Payout | Payout |
| 25 | 3 to 2 | N/A | N/A | N/A | N/A |
| 26 | 3 to 2 | 4 to 3 | 6 to 5 | 1 to 1 | N/A |
| 27 | 3 to 2 | 4 to 3 | 6 to 5 | 1 to 1 | 3 to 2 |
| 28 | 3 to 2 | 4 to 3 | 6 to 5 | 1 to 1 | 3 to 2 |
| 29 | 2 to 1 | 3 to 2 | 3 to 2 | 3 to 2 | 2 to 1 |

In the preferred embodiment, the Bonus wager must be placed before the player receives their initial two cards, and must be equal to the Ante wager. In an alternative embodiment, the Bonus wager may be different from the Ante wager. The Bonus wager combines the player's cards with the initial five community cards to compete against the Bonus wager payout table. The Bonus wager pays the highest scenario achieved in accordance with the Bonus wager pay table. In some embodiments, the Ante wager and Bonus wager are determined independently and a player may win one and lose the other. In some embodiments, the player must win the Ante wager in order to win the Bonus wager. In some embodiments, the player must win the Bonus wager in order to win the Ante wager. In the preferred embodiment, the Bonus wager wins if any of the below example conditions are met:
Both of the player's cards and the community cards include three cards of the same kind/value
Both of the player's cards and the community cards include four or more cards of the same color
Both of the player's cards and the community cards include four or more cards which form a link, i.e., a continuous numerical sequence of two or more cards. The 1/14 card is considered to be adjacent to both the 2 card and the 13 card.

The payouts for various win conditions can be varied. Examples of some preferred win conditions and associated payout options are shown in Table 2 below.

TABLE 2
Pays - Bonus Wager

| Scenario | Payout Table 1 | Payout Table 2 | Payout Table 3 |
|---|---|---|---|
| 5 of a Kind | 30 to 1 | 30 to 1 | 30 to 1 |
| 5 Card Link | 10 to 1 | 5 to 1 | 5 to 1 |
| 5 Cards Same Color | 7 to 1 | 6 to 1 | 4 to 1 |
| 5 Cards Diff Colors | 7 to 1 | 2 to 1 | 2 to 1 |
| 4 of a Kind | 7 to 1 | 7 to 1 | 7 to 1 |
| 4 Card Link | 4 to 1 | N/A | 2 to 1 |
| 4 Cards Same Color | 4 to 1 | 4 to 1 | 4 to 1 |
| 3 of a Kind | 3 to 1 | 3 to 1 | 3 to 1 |
| 5 Card Link Same | N/A | 20 to 1 | N/A |
| Color | | | |

In some embodiments, the method for playing a casino game, includes

dealing at least two cards to at least one player who has placed an Ante wager, from a deck comprising:

at least two series of cards, wherein the cards have a numerical value from 1 to n wherein n is any whole number, and

wherein each series of cards consists of cards having the same color and wherein each series has a distinct color;

dealing and/or revealing at least one community card,

determining the numerical values of the two cards dealt to each player plus the numerical value of the revealed community cards.

resolving a round of the game by completing the following actions:
A. paying each player where the at least two player cards plus the revealed community cards have a collective numerical value which satisfies at least one Ante wager win condition in accordance with greatest payout odds matching the at least one Ante wager win condition,
B. removing each Ante wager where the at least two player cards plus the revealed community cards have a collective numerical value which exceeds a maximum Ante wager win condition value,

resolving additional rounds of the game upon satisfaction of additional round conditions, said additional rounds comprising:
i. wherein at least one player has player cards and revealed community cards which have a total below a minimum Ante wager win condition value,

wherein additional rounds are conducted by revealing at least one additional community card and resolving the round, and

wherein additional rounds of the game are conducted until the additional round conditions are not met.

The method above can optionally additionally include:

determining whether the at least two player cards and revealed community cards for each player who has placed a Bonus wager meet any win conditions of the Bonus wager, and

resolving the Bonus wager by completing the following actions:

a) paying each player whose at least two player cards and revealed community cards satisfy at least one Bonus wager win condition in accordance with greatest payout odds matching the at least one Bonus wager win condition satisfied, and

b) removing each Bonus wager where the players cards fail to satisfy any win condition of the Bonus wager.

The methods above can optionally additionally include wherein the win conditions for the Ante wager are satisfied when a total numerical value of the player cards and the revealed community cards is between 25 and 29.

The method A above can optionally additionally include: wherein the payout odds for the Ante wager win conditions comprise:

3:2 where the total numerical value of the player cards and the revealed community cards are between 25 and 28, and

2:1 where the total numerical value of the player cards and the revealed community cards are 29.

The methods above can optionally additionally include wherein the win conditions for the Bonus wager include:

three cards all having the same numerical value, four cards all having the same color, four cards having the same numerical value, four cards have sequential numerical values, five cards all having the same color, five cards having the same numerical value, five cards have sequential numerical values, five cards all having different colors.

The methods above can optionally additionally include wherein the payout odds for the Bonus wager win conditions include:

3:1 wherein three cards all have the same numerical value, 4:1 wherein four cards all have the same color, 7:1 where four cards have the same numerical value, 4:1 where four cards have sequential numerical values, 7:1 wherein five cards all have the same color, 30:1 where five cards have the same numerical value, 10:1 where five cards have sequential numerical values, 7:1 where five cards all having different colors.

In some methods above n equals 14.

In some methods above the game is played on a playing surface or an electronic device.

In some methods above the game deals and then reveals a maximum of five community cards over a maximum of 4 additional rounds.

In some methods above, a 5 total community cards are dealt and/or revealed.

In some methods above, at least of 5 community cards are revealed.

In some methods above, only the first five community cards revealed are used to determine the bonus wager outcomes.

### BRIEF DESCRIPTION OF THE DRAWINGS

FIG. 1 shows a sample game board suitable for playing the casino game.

FIG. 2 shows a game board suitable for playing the casino game of which FIG. 1 is a specific example.

FIG. 3 shows a zoomed in view of the player station and payout table of a sample game board.

FIG. 4 shows a sample video screen suitable for playing a digital version of the casino game.

FIG. 5 shows a game board suitable for playing the casino game in digital format of which FIG. 4 is a specific example.

### DETAILED DESCRIPTION OF THE DRAWINGS

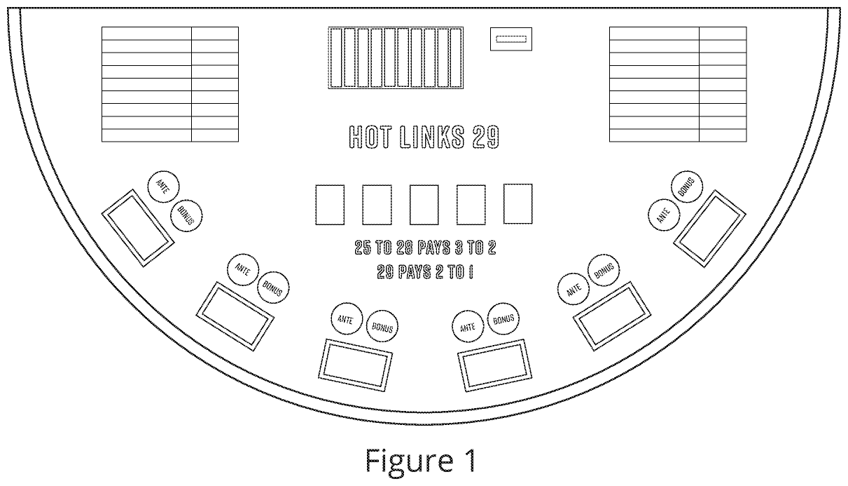

FIG. 1 is a sample game board suitable for playing the casino game. This sample shows a single embodiment of a game board of the invention.

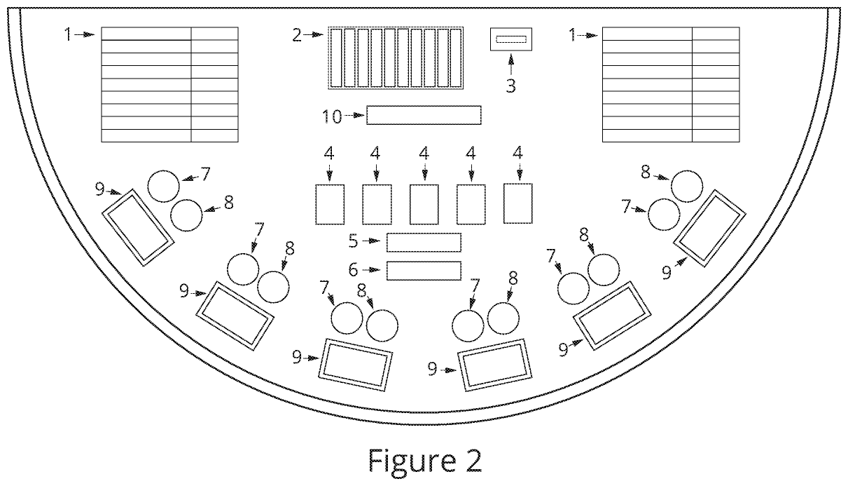

FIG. 2 show a preferred layout for a table/game board suitable for playing the casino game of which FIG. 1 is a specific example. FIG. 2 includes a Bonus payout table (1) including win conditions and associated payouts. In some embodiments, the Bonus payout table (1) is presented as text on the game board rather than in an actual table. In the preferred embodiment, the Bonus payout table (1) is located on either side of the board. In the preferred embodiment, the Bonus payout table (1) is located in a position such at its payouts and win conditions are easily viewable to all players.

The dealer's chip tray (2) is positioned where the facility which operates the game stores its chips, i.e., the house. The displayed option in the figure places the chip tray (2) in the center of the table opposite where the players are positioned. The value of the chips is determined by the facility which operates the game. The chips can have any value, for example, $1, $5, $10, $25, $100, or $500. The purpose of the chip tray is to convert the player's cash into money chips which are of the same value of the player's cash money. These chips are used for wagers offered by the players, and the chip tray (2) is the location where the chips are removed from to pay the player's winning wagers, and the location to store the chips from the players that lose wagers.

The chip tip slot (3) is used for dealers to store the chips that are given to the dealer in the form of a tip from the players. The chip tip slot (3) may be positioned anywhere. In the preferred embodiments, it is positioned within reach of the dealer and/or closer to the dealer than to the players.

The table of FIG. 1 also includes a community cards spot (4). The community cards spot (4) is a visually defined location where the dealer places the community cards. The community cards are cards that each player combines with the cards that are dealt to the player to compete against the Ante and Bonus wagers payout tables. These cards are revealed one at a time after the players place an additional Ante and/or Bonus wager. In the preferred embodiment, the community cards spot (4) is located at or near the center of the table i.e., at an equal distance to all player table positions.

The Ante payout table (5) includes win conditions and associated payouts. In some embodiments, the Ante payout table (5) is presented as text on the game board rather than in an actual table. In the preferred embodiment, the Ante payout table (5) is centrally located. In the preferred embodiment the Ante payout table (5) is located in a position such at its payouts and win conditions are easily viewable to all players. The Special Ante payout table (6) provides special win conditions and associated payouts which are associated with the Ante wager but are different from the those presented in the Ante payout table (5). In the preferred embodiment the Special Ante payout table (6) is directed to events with lower odds of occurring and higher payouts than the Ante payout table (5). In the preferred embodiment the Special Ante payout table (6) is located in the same general area of the game board as the Ante payout table (5).

The player's Ante wager spot (7) is a visually defined location where a player must place chips in to place an Ante wager which is required to play the game. The Ante wager must be placed in the Ante wager spot (7) prior to the player receiving their initial cards and before the revealing any community card.

The player's Bonus wager spot (8) is a visually defined location where a player must place chips into in order to place a Bonus wager. In the preferred embodiments, this is an optional bet which is not mandatory to play the game. In the preferred embodiments, the Bonus wager amount must be equal to or less than the Ante wager. If the player decides to place the optional Bonus wager, the Bonus wager must be placed in the Bonus wager spot (8) prior to receiving the player's cards or the revealing of a community card.

The player's cards spot (9) is a visually defined location where the dealer places the player's cards. That is, in the preferred embodiments, the cards dealt to the player after an Ante wager is placed in the Ante wager spot (7) are dealt to the player's cards spot (9). In the preferred embodiment, the player's cards spot (9) is located close to where a player is sitting at the table.

The game title (10) is displayed on the table. In the preferred embodiment the title (10) is displayed below the dealer's chip tray (2).

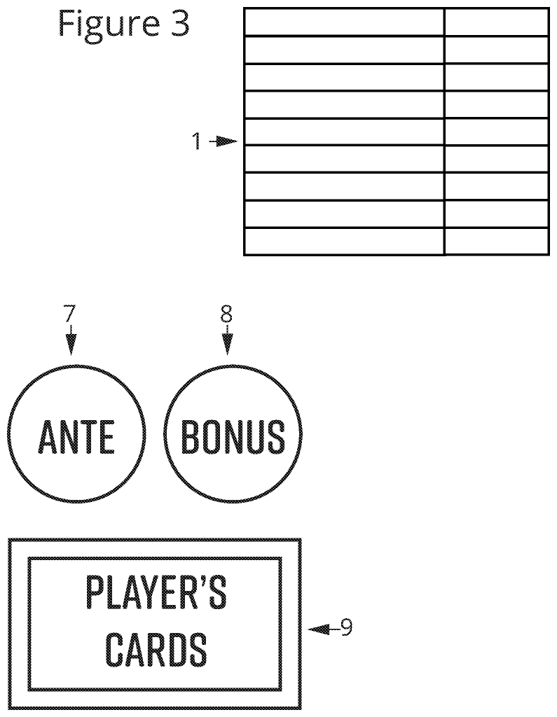

FIG. 3 shows a zoomed in view of the player station and payout table of a sample game board. The Bonus payout table (1) is shown positioned above the Ante wager spot (7), Bonus wager spot (8), and the player's cards spot (9). In the preferred embodiment the Ante wager spot (7), Bonus wager spot (8), and the player's cards spot (9) are located in close proximity to each other, i.e., bunched together. The individual spots are optionally different shapes. In the preferred embodiment, the Ante wager spot (7) and Bonus wager spot (8) are the same shape and the player's cards spot (9) is a different shape.

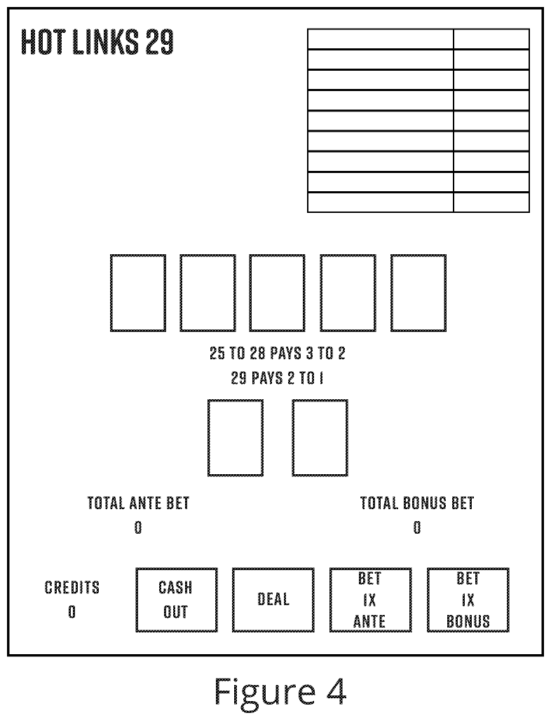

FIG. 4 illustrates a single example of a digital version of the casino game. The display shown is only for a single user.

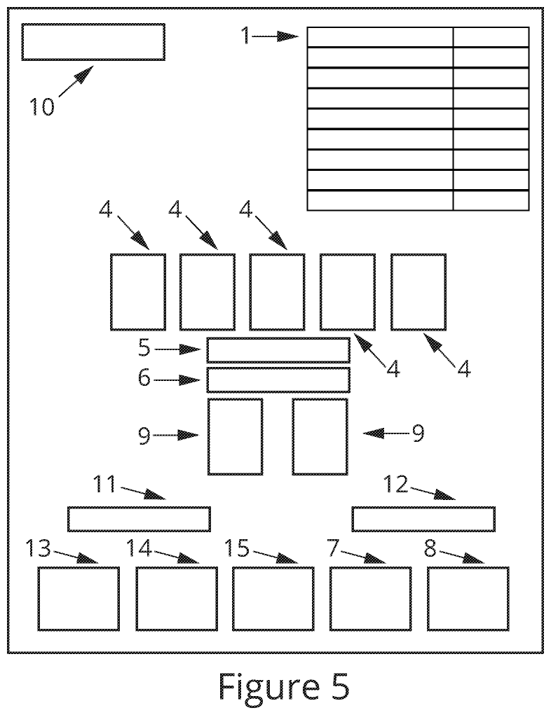

FIG. 5 shows a game board suitable for playing the casino game in digital format of which FIG. 4 is a specific example. Elements (1)-(10) are as described above. FIG. 5 also includes a total Ante bet display (11) which displays the amount bet as the Ante wager and a total Bonus bet display (12) which displays the amount bet as the Bonus wager.

The user's total credits available for wagering is displayed in the credits display (13). The cash out button (14) is selectable by a user and allows a user to retrieve their credits in the form of money or a ticket/credit that can be exchanged for money or prizes.

The deal button (15) is selectable by a user and activates a new game. After selecting the deal button (15) the wagered credits in the Ante wager (11) and optionally the Bonus wager (12), all bets are put at risk and the cards are dealt to begin the game.

What is claimed is:

1. A method for playing a casino game comprising:
dealing at least two cards to at least one player who has placed an Ante wager, from a deck comprising:
at least two series of cards, wherein the cards have a numerical value from 1 to n wherein n is any whole number, and
wherein each series of cards consists of cards having the same color and wherein each series has a distinct color;
dealing and/or revealing at least one community card,
determining the numerical values of the two cards dealt to each player plus the numerical value of the revealed community cards,
resolving a round of the game by completing the following actions:
A. paying each player where the at least two player cards plus the revealed community cards have a collective numerical value which satisfies at least one Ante wager win condition in accordance with greatest payout odds matching the at least one Ante wager win condition,
B. removing each Ante wager where the at least two player cards plus the revealed community cards have a collective numerical value which exceeds a maximum Ante wager win condition value,
resolving additional rounds of the game upon satisfaction of additional round conditions, said additional rounds comprising:
i. wherein at least one player has player cards and revealed community cards which have a total below a minimum Ante wager win condition value,
wherein additional rounds are conducted by revealing at least one additional community card and resolving the round, and
wherein additional rounds of the game are conducted until the additional round conditions are not met.

2. The method for playing a casino game of claim 1 additionally comprising
determining whether the at least two player cards and revealed community cards for each player who has placed a Bonus wager meet any win conditions of the Bonus wager, and
resolving the Bonus wager by completing the following actions:
a) paying each player whose at least two player cards and revealed community cards satisfy at least one Bonus wager win condition in accordance with greatest payout odds matching the at least one Bonus wager win condition satisfied, and
b) removing each Bonus wager where the players cards fail to satisfy any win condition of the Bonus wager.

3. The method of claim 1 wherein the win conditions for the Ante wager are satisfied when a total numerical value of the player cards and the revealed community cards is between 25 and 29.

4. The method of claim 3 wherein the payout odds for the Ante wager win conditions comprise:
3:2 where the total numerical value of the player cards and the revealed community cards are between 25 and 28, and
2:1 where the total numerical value of the player cards and the revealed community cards are 29.

5. The method of claim 2 wherein the win conditions for the Bonus wager comprise:
three cards all having the same numerical value, four cards all having the same color, four cards having the same numerical value, four cards have sequential numerical values, five cards all having the same color, five cards having the same numerical value, five cards have sequential numerical values, five cards all having different colors.

6. The method of claim 5 wherein the payout odds for the Bonus wager win conditions comprise:
3:1 wherein three cards all have the same numerical value, 4:1 wherein four cards all have the same color, 7:1 where four cards have the same numerical value, 4:1 where four cards have sequential numerical values, 7:1 wherein five cards all have the same color, 30:1 where five cards have the same numerical value, 10:1 where five cards have sequential numerical values, 7:1 where five cards all having different colors.

7. The casino game of claim 1, wherein n equals 14.

8. The casino game of claim 1, wherein the game is played on a playing surface or an electronic device.

9. The casino game of claim 1, wherein the game deals and then reveals a maximum of five community cards over a maximum of 4 additional rounds.

10. The casino game of claim 1, wherein 5 total community cards are revealed.

11. The casino game of claim 1, wherein at least of 5 community cards are revealed.

12. The casino game of claim 11, wherein only the first five community cards revealed are used to determine the bonus wager outcomes.
